(19) United States
(12) Patent Application Publication
(10) Pub. No.: US 2005/0124247 A1
(43) Pub. Date: Jun. 9, 2005

(54) Metal spiral fabrics for corrugator machines

(76) Inventor: Alan L. Billings, Clifton Park, NY (US)

Correspondence Address: FROMMER LAWRENCE & HAUG, 745 FIFTH AVENUE- 10TH FL., NEW YORK, NY, 10151, US

(21) Appl. No.: 10/720,489

(22) Filed: Nov. 24, 2003

(51) Int. Cl. B32B 1/00; D03D 15/00

(52) U.S. Cl. 442/229; 428/221

(57) ABSTRACT

The present invention relates to a singlefacer or doublebacker belt having a endless spiral-link base structure. The base structure includes a top surface and a bottom surface, and further includes a plurality of side-by-side metal spirals, each spiral defining an internal space, wherein the spirals are interconnected by a series of parallel pintles extending through the internal spaces of adjacent spirals.

### BACKGROUND OF THE INVENTION

1. Field of the Invention

The present invention relates to corrugated paper board manufacture and to the belts required by the machines used to manufacture that variety of paper board. More specifically, the present invention relates to the belts that may be used on the singlefacer and/or doublebacker sections of a corrugated board production line.

2. Description of the Prior Art

In the manufacture of corrugated paper board, a so-called core paper is heated by steam, which makes it more pliable, and is then fed into a nip formed between a pair of toothed rollers whose teeth mesh, thereby corrugating the core paper in a uniform, undulating pattern. Starch paste is subsequently applied to the crests of the corrugated core paper, which is then mated to a liner paper in a press nip. There, the corrugated core paper and liner paper are bonded together to form a completed sheet, which can then be further processed as desired.

In one machine used for this purpose in the prior art, the press nip is formed by one of the toothed or corrugating rolls and a pressure roll. In another machine of a more recent design, the press nip is extended in the running direction through the use of a belt instead of a pressure roll. The belt holds the corrugated core paper and liner paper together against the corrugating roll for a significant portion of its circumference.

The belt experiences severe operating conditions. Because heat is used to vaporize moisture in the core paper, the belt operates in a high-temperature environment. Further, the belt continually runs, albeit with the corrugated board sheet between, against the teeth on the corrugating roll to develop the required bonding pressure between the core paper and the liner paper. Moreover, the belt must be flexible yet have lengthwise strength and widthwise rigidity sufficient to withstand wrinkling, which may cause the belt to drift undesirably from side to side.

Some prior art singlefacer belts are constructed of a woven base fabric, usually of synthetic yarns, and a surface of fiber applied by needling. In addition, some belts may be just the woven structure with no needled batt fiber. Either type of belt can have a coating or a resin impregnation for added abrasion resistance or to enhance other belt characteristics. Note that a woven metal fabric with brazed or similar seam is also common. While the synthetic construction provides advantages in some applications and with certain belt configurations, this construction may result in low wear resistance, poor strength, limited heat conduction, and the probability of separation of the base from the cover. As to belts of metal construction, oftentimes there is inherent weakness in the seam.

Also as to doublebacker belts, they are typically constructed of synthetic yarns, woven and sometimes subsequently needlepunched, and also synthetic monofilament yarns made into spiral-link fabrics. Again, while such belts provide advantages in some applications and with certain belt configurations, they may suffer from low wear resistance, insufficient permeability, poor seam strength, and the probability of seam marking. Similarly with synthetic spiral-link fabrics, they may result in low wear resistance, inferior strength, and a less than desirable weight per unit area.

While the foregoing have attendant advantages as aforenoted, further improvements and/or alternative forms, are always desirable. Accordingly, the present invention provides an improvement and/or solution to the problems inherent in the use of a belt of the foregoing varieties.

### SUMMARY OF THE INVENTION

It is the object of the present invention to provide an improved belt for use in the manufacture of corrugated paper board.

It is a further object of the present invention to provide a belt with improved strength, wear resistance, and heat conduction.

It is a further object of the present invention to provide a belt that demonstrates improved wear resistance, permeability, and seam strength.

These and other objects and advantages are provided by the present invention. In this regard, the present invention is directed towards a singlefacer belt having an endless base structure with a top surface and a bottom surface. The base structure is formed by a plurality of side-by-side metal spirals. Each spiral defines an internal space, and the spirals are interconnected by a series of parallel metal pintles extending through the internal spaces of adjacent spirals.

The present invention is also directed towards a doublebacker belt having an endless base structure with a top surface and a bottom surface. The base structure is formed by a plurality of side-by-side metal spirals. Each spiral defines an internal space, and the spirals are interconnected by a series of parallel pintles extending through the internal spaces of adjacent spirals.

The various features of novelty which characterize the invention are pointed out in particularity in the claims annexed to and forming a part of this disclosure.

### BRIEF DESCRIPTION OF THE FIGURES

For a more complete understanding of the invention, reference is made to the following description and accompanying drawings, in which:

FIG. 1 shows a typical belted singlefacer corrugated board production line;

FIG. 2 is a plan view of a section of the metal spiral-link base structure for the singlefacer or doublebacker belt according to the present invention;

FIG. 3 is a cross sectional view of the metal spiral-link base structure shown in FIG. 2, according to the present invention; and

FIGS. 4A and 4B show doublebacker corrugated board machines utilizing the belts of the present invention.

### DETAILED DESCRIPTION OF THE PREFERRED EMBODIMENTS

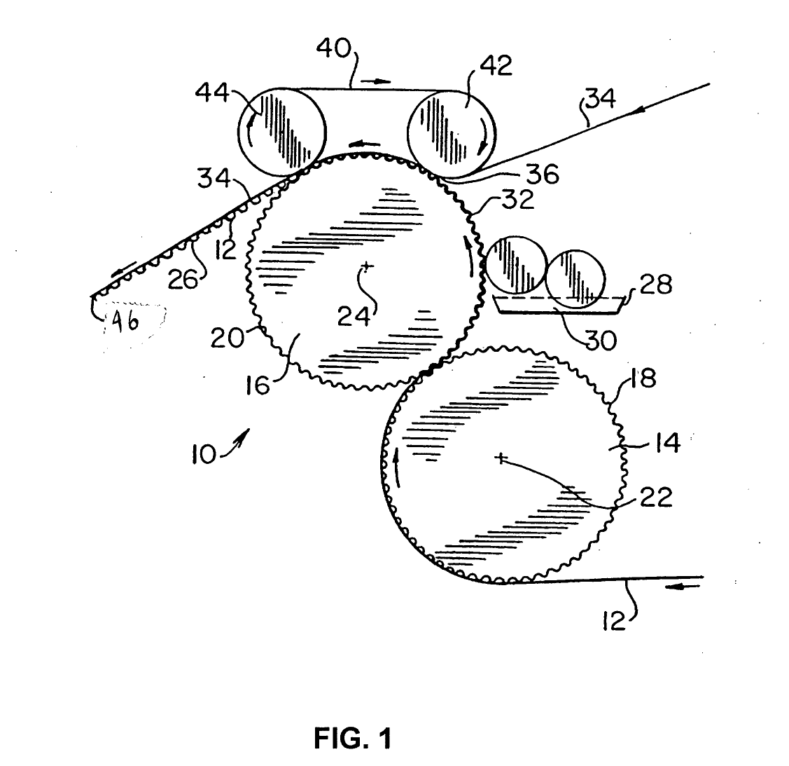

Turning now to these figures, FIG. 1 is a schematic view of a typical belted singlefacer section 10 of a corrugated board production line. A core paper 12, previously exposed to steam which makes it more pliable, is fed continuously between a pair of cooperating rolls 14, 16. The rolls 14, 16 have uniformly spaced, peripheral teeth 18, 20, which mesh as the rolls 14, 16 rotate about their respective, parallel axes 22, 24. The meshing teeth 18, 20 produce corrugations 26 in the core paper 12.

A coating mechanism 28 applies a starch paste 30 to the crests 32 of the corrugations 26 in the core paper 12.

The corrugated core paper 12 is continuously applied to a liner paper 34 at point 36, where a belt 40, which is trained around a pair of spaced rollers 42, 44, passes around roller 42. The spaced rollers 42, 44 are so disposed that belt 40 bears against roll 16, and both may form nips with roll 16, so that the belt 40, trained thereabout, bears against roll 16 for the entire interval between spaced rollers 42, 44 forming an extended nip between roll 16 and belt 40. Heat is applied to the corrugated core paper 12 and liner paper 34 through at least one of the rollers 42, 44, belt 40 and roll 16. The heat vaporizes water absorbed by the corrugated core paper 12 when the corrugated core paper 12 was exposed to steam and dries the starch paste 30.

The rollers 42, 44 are situated so that the teeth 20 on roll 16 bear against the outside surface of the belt 40 over a substantial circumferential extent as the system operates. The teeth 20 maintain the proper registration of the corrugated core paper 12 as it is advanced. At the same time, the roll 16 firmly presses the side of the core paper 12 with the paste thereon against the liner paper 34 to effect bonding there between. The corrugated core paper 12 with the liner paper 34 attached thereto exits as a singleface product 46 from between the roll 16 and the roller 44.

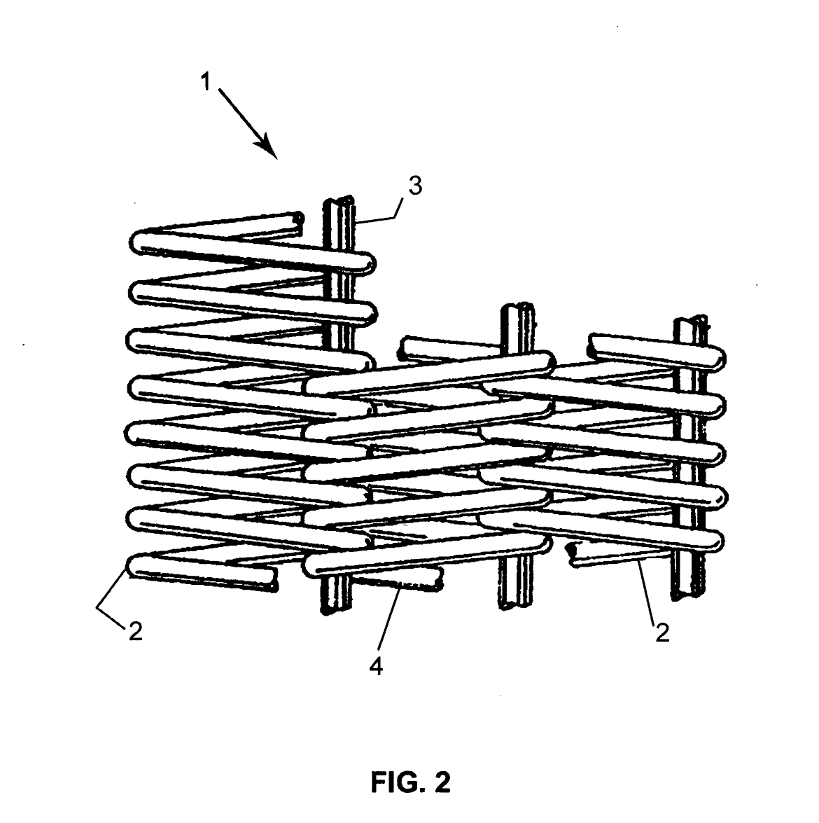

In one embodiment, the belt of the present invention may be a singlefacer belt used on, for example, the above described corrugator board machine. In this connection, FIG. 2 is a plan view illustrating a portion of a metal spiral-link base 1 which forms part of the belt according to the present invention. As can be seen, the metal spiral-link base 1 is constituted of oppositely oriented axially extending spirals 2, 4. In FIG. 2, spirals 2 are oriented in one direction, for example, with their upper portions being inclined leftwardly, while spirals 4 are oriented oppositely, for instance, with their upper portions inclined to the right between spirals 2.

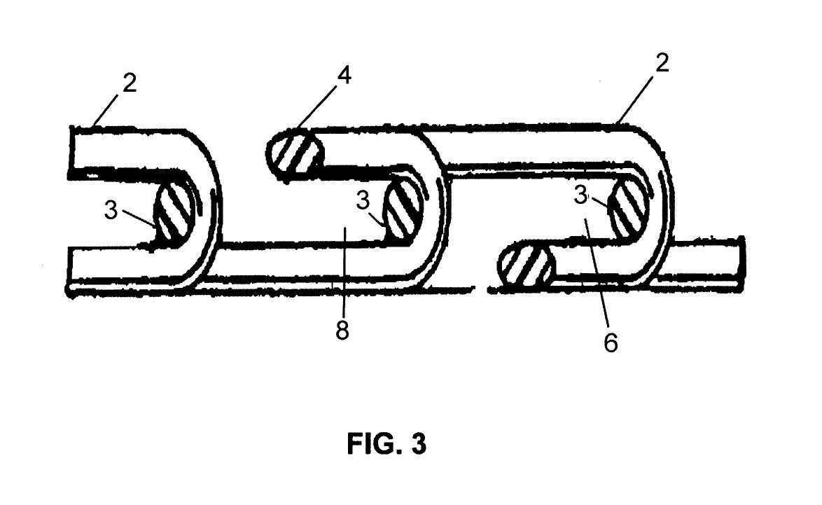

The metal spirals 2 and 4 extend along parallel longitudinal axes. Referring now to FIG. 3, the spirals 2 and 4 define longitudinally extending internal passages 6, 8, respectively. As can be seen, spirals 2 and 4 are arranged to overlap each other, so that the end portions of internal spaces 6, 8 overlap. In this connection, pintles 3 extend through the overlapping portions of the spiral internal spaces 6, 8, to connect spirals 2 and 4 into a continuous material.

The helical spiral-link base 1 of the belt may be produced from a variety of metal materials. While stainless steel is most common, other metals suitable for the purpose can be used, especially if certain properties are desired. Also, while the metal material which forms the spirals 2, 4 can be round in cross section, flat spirals or other shapes suitable for the purpose can be utilized. In addition, the spirals 2, 4 can be interlaced or non-interlaced, and the spacing between the turns of a respective spiral can be wider or narrower as desired. Finally, it is noted that filler means, for example, a plurality of flat bars (not shown) or other elements suitable for the purpose, can be disposed within the spirals 2, 4 with a view to varying the permeability or surface condition of the inventive belt.

As described above, the use of the metal spiral-link base 1 to form a belt enables the present invention to provide improved operation and other advantages. For example, the singlefacer belt of the invention offers better wear resistance, greater strength and better heat conduction than prior synthetic belts, as well as stronger seams than prior art woven metal fabrics having brazed or similar seams.

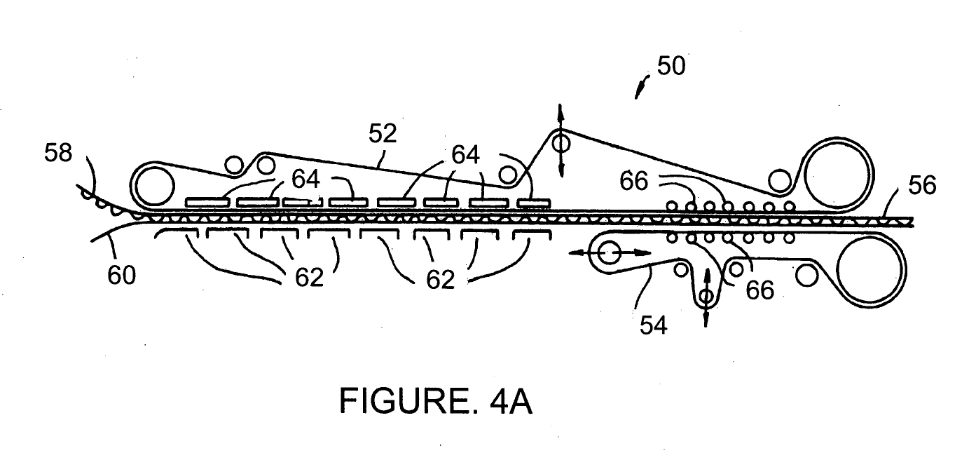

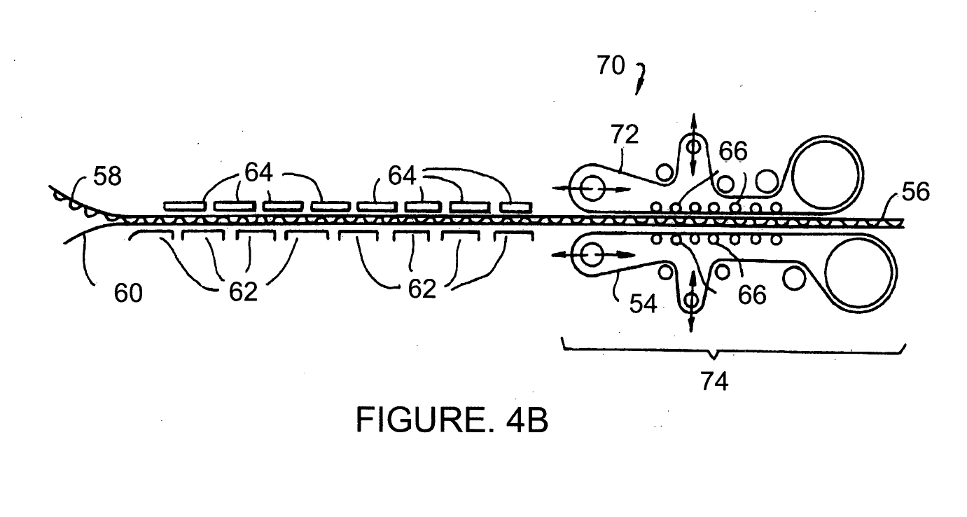

In a second embodiment, the inventive belt with metal spiral-link base 1 can be a doublebacker belt used on the doublebacker section shown in FIGS. 4A and 4B. The corrugator machine 50 in FIG. 4A has an upper belt 52 and a lower belt 54 which together pull a corrugated paper product 56 therethrough. Corrugated paper product 56 includes a corrugated layer 58 and an uncorrugated layer 60, which are joined to one another in the machine 50 by means of a suitable adhesive. Layers 58 and 60 are brought together at one end of the machine 50 and are pulled by belt 52 across a series of hot plates 62 to dry and/or to cure the adhesive which bonds the paper layers together.

After passing over hot plates 62, the upper and lower belts 52, 54 together pull the corrugated paper product 56 between them, maintaining the speed of the operation and cooling the paper product 56. Weighted rollers 66 apply pressure from within the endless loops formed by belt 52 and belt 54 toward one another, so that corrugated paper product 56 may be held therebetween firmly. Upon exit from between the upper and lower belts 52, 54, the corrugated paper product 56 is cut and/or stacked as required.

FIG. 4B shows a doublebacker section in which the upper belt 52 is replaced with a much shorter belt 72. In this case, the upper belt 72 does not pass across the hot plates 62. Instead, the upper belt 72 is disposed opposite the lower belt 54 downstream from hot plates 62 in what may be referred to as cooling, or pulling, zone 74.

In this variety of corrugator machine 70, weighted steel shoes push the corrugated paper product 56 against the hot plates 62. In this case, the upper and lower belts 72, 54 disposed downstream from hot plates 62 pull the corrugated paper product 56 through the machine 70. As before, weighted rollers 66 apply pressure from within the endless loops formed by belt 72 and belt 54 toward one another, so that corrugated paper product 56 is firmly held therebetween. Again, upon exit from between belts 52, 54, the corrugated paper product 56 is cut and/or stacked.

Accordingly, when used on the above described corrugator machines, the doublebacker belt of the present invention exhibits better wear resistance, improved permeability and greater resistance to seam marking than prior woven synthetic belts, as well as better wear resistance, greater strength and improved weight per unit area as compared with prior synthetic spiral-link fabrics.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

1. A belt for use on a corrugator machine in the manufacture of corrugated packaging board, said belt comprising an endless spiral-link base, said base defining a top surface and a bottom surface and including a plurality of metal spirals, each spiral defining an internal space, wherein the spirals are interconnected by a series of parallel pintles extending through the internal spaces of adjacent spirals.

2. The belt of claim 1, wherein the belt is used as a singlefacer belt.

3. The belt of claim 1, wherein the metal spiral-link base comprises stainless steel.

4. The belt of claim 2, wherein the singlefacer belt has better wear resistance, greater strength, and better heat conduction than non-metal belts, as well as stronger seams than woven metal fabrics having brazed seams.

5. The belt of claim 1, wherein the belt is a doublebacker belt.

6. The belt of claim 5, wherein the doublebacker belt has better wear resistance, greater strength, lower probability of seam marking, stronger seams, and greater permeability than non-metal belts.

7. The belt of claim 1, further comprising filler means disposed within said spirals.
